(19) United States
(12) Patent Application Publication
(10) Pub. No.: US 2024/0420158 A1
(43) Pub. Date: Dec. 19, 2024

(54) NFT CARBON CREDIT TRACKING

(71) Applicant: Datacurve, Inc., Los Altos, CA (US)

(72) Inventors: Rakesh Ramde, Los Altos, CA (US); Amanjyot Singh Johar, Sunnyvale, CA (US)

(73) Assignee: Datacurve, Inc., Los Altos, CA (US)

(21) Appl. No.: 18/669,123

(22) Filed: May 20, 2024

Related U.S. Application Data
(60) Provisional application No. 63/467,722, filed on May 19, 2023.

(51) Int. Cl. G06Q 30/018; G06Q 20/36

(52) U.S. Cl. CPC G06Q 30/018; G06Q 20/3672

(57) ABSTRACT

Carbon usage is monitored and recorded from emissions of one or more sources associated with carbon consumers. Public and private metadata about sources are maintained. A block chain records carbon credit transactions representing savings in the carbon footprint.

### CROSS-REFERENCE TO RELATED APPLICATIONS

The invention claims priority under 35 USC 119 (e) to 63/467,722, entitled NFT CARBON CREDIT TRACKING, and filed May 19, 2023, by Ramde et al., the contents of which are hereby incorporated in its entirety.

### FIELD OF THE INVENTION

The invention relates generally to computer networks, and more specifically, to registering, tracking and verifying carbon credits using NFTs.

### BACKGROUND

Carbon credits are a tool used in the fight against climate change. They represent the right to emit a certain amount of carbon dioxide or other greenhouse gasses, and they can be bought, sold, and traded on regional marketplaces. However, the process of creating, using, trading, and redeeming carbon credits is extremely opaque and there is little information available to verify the authenticity of these carbon credits.

Carbon credits markets have been subject to a number of problems and criticisms. Some of the key issues are:

No-standardization: One of the biggest problems with carbon credits markets is that because of no clear standardization, there is often an oversupply of credits, which can drive down the price and reduce the incentive for companies to reduce their emissions. This is partly due to the fact that some countries have set emissions reduction targets that are relatively easy to achieve, leading to an excess of credits.

Lack of transparency: Another issue is that the market can lack transparency, making it difficult for buyers and sellers to know what they are getting. There have been instances of fraudulent credits being sold, as well as concerns about double-counting and the accuracy of emissions measurements. As such, these markets remain at the risk for market manipulation by large financial institutions and corporations as they can use their market power to manipulate the prices of the carbon credits.

Inconsistent regulation: The regulation of carbon markets varies widely from country to country, leading to a lack of consistency and accountability. Some markets have weak oversight, while others are highly regulated, making it difficult for companies to navigate the complex rules.

Volatility: Carbon credits markets can be highly volatile, with prices fluctuating based on factors such as changes in government policy and the supply and demand for credits.

Carbon credits is a market-driven way for companies to avoid having to take meaningful action to reduce their emissions. Rather than investing in clean technologies and processes, companies can simply buy credits to offset their emissions, which can be seen as a way of “greenwashing” their image without actually reducing their impact on the environment.

There are various carbon credit verification companies, yet they do not rigorously maintain standards, nor do they publish or register these carbon credits in a way that can be transparently verified by third parties.

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token. An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens. With some tokens, the token may be minted on demand when the token creator decides to mint the token. Some fungible tokens are minted and initially allocated via an initial coin offering. Some tokens are “pre-mined” and subsequently allocated. For example, once minted, an NFT can be offered for sale or acquisition via an NFT marketplace or other token sale platform.

The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, closed to external sources. This can be problematic when external data is needed to satisfy conditions or functions of the smart contract.

By using a blockchain-based system and specifically NFTs for recording carbon credits and streamlining carbon credit transactional markets, the industry experience could be significantly enhanced. Businesses and brands of all sizes can easily prove their commitment to reducing carbon, create sustainable global supply chains, and make their spending on innovation more productive. The decentralized nature of blockchain could also make it more difficult for unauthorized individuals to access or tamper with such NFT based credits. Moreover, blockchain-based resource and communication tools could facilitate data sharing between various departments of the business, such as customer service, marketing, and operations. It can also facilitate data sharing between a business and its partners for example, between Walmart and its suppliers. Additionally, the use of smart contracts on a blockchain could potentially automate various aspects of the customer experience and customer success programs deployed widely in organizations. Finally, the use of NFTs incentivizes the holders of the NFTs with recognition and rewards while reinforcing positive behaviors, skills or outcomes for natural communities of said businesses, organizations, suppliers, users, and other ecosystem participants, who could all benefit from sharing data in a unique manner.

Therefore, what is needed is a robust technique for registering and tracking carbon credits with NFTs.

### SUMMARY

To meet the above-described needs, methods, computer program products, and systems for registering and tracking carbon credits with NFTs.

Carbon credits are meant to represent a real-world reduction in greenhouse gas emissions, which requires accurate measurement and verification. As such, what is required is an accurate way of measuring the savings in carbon reductions, as well as documenting the savings via immutable technique and assigning provenance that can eliminate the risk of double counting as well as resolve the ownership and retirement claims associated with such credits.

In one embodiment, a business establishes an NFT token concerning a specific carbon emission reduction program. As a result of investing in the reduction of carbon emissions, the business can claim either regulated or voluntary credits as the case may be. This would also be specified for the token associated with the realized savings. The business history is updated every time the NFT token smart contract mints a corresponding token taking into account the various data sources or programs that the business may be a part of. An NFT engine mints NFT tokens and processes and secures transactions. The NFT token can be accessed by a third party to review and use embedded data to verify the business claims of actually reducing carbon emissions or any other purposes in a transparent manner.

In one embodiment, the data may include the business name, organization, business unit, data from telemetry systems, or energy meters, solar panels, carbon accounting software, energy consumption data, transportation data, weather, supply chain, emission inventories, or any other specific industry benchmarks etc. In addition to a user wallet, the system may also create a decentralized identity for the buyers and sellers of the carbon credits. This decentralized identity can further be associated with the various programs that the business may be involved with and create a singular source of truth for the overall carbon footprint of the organization, without compromising the private data of any one program that it may be involved in.

In one embodiment, the system is governed by configurable smart contracts. Smart contracts are self-executing contracts with the terms of the agreement directly written into code. Smart contracts enable automated and tamper-proof agreements, facilitating various applications such as decentralized finance (DeFi), non-fungible tokens (NFTs), and decentralized exchanges (DEXs). The carbon ecosystem, comprising businesses, NGOs, regulators, marketplaces, private interests, financial markets, etc. are all incentivized to transact within a network. It may be desirable from a business and convenience perspective that the digital assets may only be traded and governed by the rules in the smart contract(s). In one embodiment, the digital assets may be blocked from trading on any third party systems, exchanges, protocols etc., thereby making it a singular registry of carbon data and digital assets related to carbon emissions and environment.

Advantageously, carbon credit tracking is more reliable, verifiable and secure.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to register and track carbon credits with NFTs, according to an embodiment.

FIG. 2 is a high-level block diagram illustrating an architecture of the NFT Engine and its components, according to an embodiment.

FIG. 3 is a block diagram illustrating an exemplary architectural view of a sports NFT marketplace and applications, according to an embodiment.

FIG. 4 is a block diagram illustrating the elements of the LogicWare with artificial intelligence, blockchain and Web3 interfaces, according to an embodiment.

FIG. 5 illustrates the use of verified credentials (VCs) for authentication into the ecosystem of applications for access control or user onboarding features, according to an embodiment.

FIG. 6 is a more detailed block diagram illustrating an NFT carbon credit module of the system of FIG. 1, according to an embodiment.

FIG. 7 is a high-level flow diagram illustrating a method for registering and tracking carbon credits with NFTs, according to one embodiment.

FIG. 8 is a more detailed flow diagram illustrating an alternative method for registering and tracking carbon credits with NFTs, according to one embodiment

FIG. 9 is a block diagram illustrating an example computing device for the system of FIG. 1, according to one embodiment.

### DETAILED DESCRIPTION

Methods, computer program products, and systems for recording user data at a particular location, and can further segregate based on a particular time at the location. One of ordinary skill in the art will recognize many alternative embodiments that are not explicitly listed based on the following disclosure.

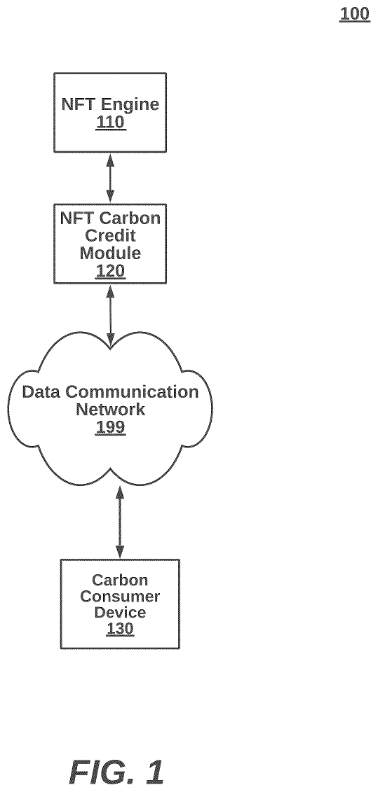

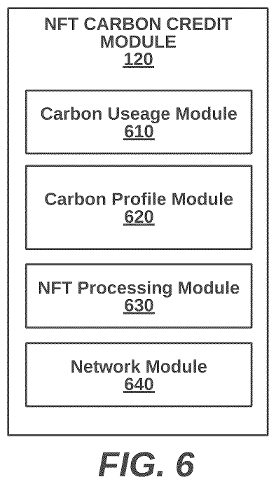

### I. Systems for NFT Carbon Credit Tracking (FIGS. 1-6)

FIG. 1 is a high-level block diagram illustrating a system 100 for registering and tracking carbon credits with NFTs, according to one embodiment. The system 100 includes an NFT engine 110, an NFT carbon credit module 120 interacting over a data communication network 199 with a carbon consumer device 130, as users of the system 100. In one embodiment, the NFT engine 110 and the location transaction module 120 are integrated into a single physical device, and in another embodiment, communicate across the data communication network 199. Many other variations are possible.

In one embodiment, the NFT engine 110 mints and allocates tokens based on data triggered events and provides access to token-gated content in response to satisfying specified token criteria. For example, minting a carbon credit every time a 1 tonne of saving has been realized. The credit may also be minted at any arbitrary number. Credits may also be combined together or fractionated as business or commercial terms may require for their accounting or trading purposes. Data triggered events can be monitored and anticipated via various mechanisms, such as Internet of things (IoT) devices, sensor networks, analytics from transportation, logistics, supply chain software, machine learning models that can analyze data and trigger events based on such analysis, financial data to trigger a mint and sell order for an inventory of carbon credits etc. It is also anticipated within the invention that a minting of carbon credits can be triggered by non numerical data such as social media posts, sentiment data analysis, or geo-political data analysis etc. In addition, location data can also trigger a minting of associated carbon credits. For example, a trucking fleet operator may only want to capture carbon savings while the fleet is operational in California. The backend of the NFT engine is capable of supporting multiple applications and blockchain protocols simultaneously, while each application may be deployed by a unique customer. The NFT engine 110 creates a mapping of the backend databases which may include user information (such as business information, account information, content and activity data, transactional information, compliance data, behavioral data, demographic data), digital assets, and the blockchain layer interaction to provide a simple workflow for businesses and enterprises.

The carbon credit creation and administration application can be embedded into other applications such as enterprise software systems, where it can connect to the various databases that monitor carbon footprint of the organization and track any savings thereof.

The invention provides a powerful framework for representing and managing carbon credits on the blockchain. The carbon credits represented as NFTs can carry immutable metadata detailing its origin, validation methodology, and retirement status.

Carbon credits that are minted as NFTs can be bound to the same wallet address or the same smart contract representing a collection of carbon credits from a particular carbon project. It may be noted that each project itself can be represented as an NFT with its corresponding metadata. The project NFT can also be a backpack token. This allows for associating any future carbon credit production related to the project to be associated with the project by binding it to the backpack token. The Logicware platform allows carbon credit issuers and holders to leverage advanced smart contract functionality for automated issuance, trading, and retirement of such tokens. Smart contracts may also be bound to NFTs to create smart wallets.

Smart contracts can also enforce rules around credit vintages, project types, and geographic regions to ensure transparency and compliance. For example, solar production data from a project for the entire month of July can be collected. The data can be broken into non-overlapping intervals and minted as NFTs. Each day can be represented as an NFT. Or data from July 1-July 7, for example, can be grouped together as a separate NFT to create a weekly carbon credit dataset with its own metadata and labels. Further, data from all days of the month can be grouped and represented as a monthly carbon credit dataset with its own NFT, metadata and labels. This can also be achieved by grouping the various NFTs corresponding to weekly carbon credits and composing a new NFT corresponding to a monthly carbon credit dataset, for example by using ERC998, ERC6551, ERC4337, or any other relevant standards for composable NFTs (or an equivalent standard on a non-EVM blockchain).

Any carbon credits that are minted as NFTs can be bound to a smart wallet address or the same smart contract used for creating a collection or intervals of the carbon credit data. Logicware also enables the fractionalization and bundling of carbon credits into diversified portfolios based on preferences like price, quality rating, or project category.

The Logicware platform supports various advanced authentication schemes like biometrics or multi-factor access controls. This enhances security for high-value carbon credit accounts managed by corporations, governments, or offset verifiers. The immutable and transparent nature of the blockchain provides an auditable ledger for tracking the provenance and transaction history of each carbon credit token. This traceability minimizes double-counting, fraud, and inefficiencies in carbon markets.

There are additional advantages of representing carbon credits as NFTs. Such representations for carbon credits provides a clear lineage, and interval information when the credits are traded, offset, or retired. It may also be recognized by those skilled in the art that the present invention can work in addition to other monitoring and control systems, ingesting information from such systems and making it transparent for governance, reporting and audit purposes. In case of upstream and downstream projects in a chain of projects, the carbon reporting may be represented as separate NFTs and combined together. The entire chain of projects may be represented as a single NFT, or as a set of nested NFTs, where all the NFTs may be grouped and/or owned and/or bound by the same wallet or a smart wallet. It is apparent that with such groupings, the data is split into non-overlapping intervals to avoid double counting.

The carbon application can be made available as an add on for customers of cloud computing platforms. The NFTs can be minted in accordance with corporate policies on sustainability.

The carbon application can be part of a retail, ecommerce, travel portal, or any other web application. For example, the NFTs can then be minted in accordance with a sustainability initiative program of the platform, or for any other marketing, tracking, or operational objectives.

A standalone application such as a marketplace for carbon credits can be created or updated that matches buyers and sellers of such credits.

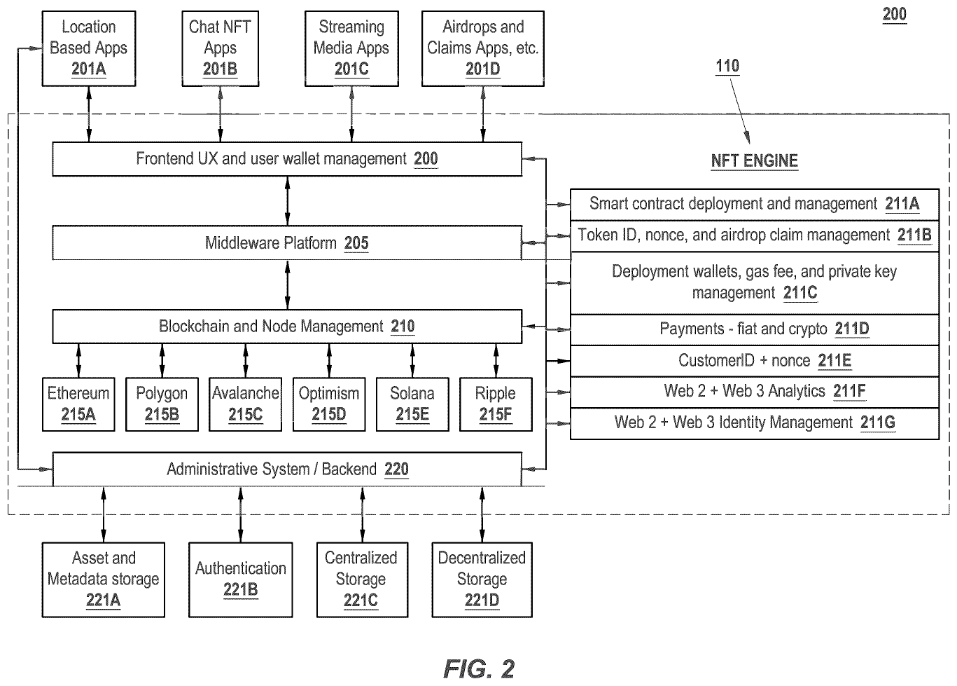

FIG. 2 illustrates one embodiment of a high level architecture 200 and incorporates the NFT engine 100 with components 211A-G. Various other components and modules can be added to the NFT engine to accommodate customized NFT requirements.

System 200 offers a variety of features for supporting various applications 201A-D including location information or user ID that is accessible from a mobile or other device. The NFT engine 100 can be triggered by scanning a QR code, accessing a specific URL that may be pre-configured with the appropriate digital assets stored to the appropriate backend databases which may be part of a marketing campaign for example. Such digital assets can also be generated in real time via GenAI applications, and presented to the user as part of another application, or being sent to the user as an SMS or message inside a messaging application.

Within the system 200, the NFT Engine 100 interfaces with a variety of other software modules including user experience modules 202 and core software infrastructure modules 205, 210 and 220. In one embodiment, the application is a location based application that is built leveraging the NFT engine 100. Application 200A could also be a non-location based application 201A or any other generic application that provides blockchain and NFT functionality to the users. NFT carbon credits apps 201B is another application or module that is responsible, for example, for showing and managing registered or past traded carbon credits. Other applications from a user experience perspective may be streaming media or digital avatar applications such as 201C or AirDrops and Claims applications 201D where users may claim an offer provided by an ecosystem partner via an NFT or a digital asset. There may be many more applications that can be built on top of the NFT engine. These applications interface directly with the NFT engine via the front end UX and user wallet management modules 202. In addition these applications interface with an administrative system or a backend, 220, which may be specific or customized for each application. The front end UX and user wallet management module 202 is connected to a middleware platform 205 (like LogicWare) which in turn connects to blockchain and node management modules 210. It may be noted that all the components of the NFT engine may also be directly interconnected with each other to ensure proper data flow, data and identity management and access controls for the users. The administrative system or backend 220 connects to various blockchains including but not limited to Ethereum (215A), Polygon (215B), Avalanche (215C), Optimism (215D), Solana (215E), Ripple (215F), or any other EVM or non-EVM blockchain via custom RPCs and APIs. The NFTs themselves can be based on ERC721, 1155, 998 (composable NFTs), or 4907 (NFT rentals), 4337 (gasless minting), 6551 (tokenbound accounts), or any other standards that may be developed or deployed. In addition the back end 220 provides support for asset and metadata storage (221A), authentication (221B), centralized storage (221C), or decentralized storage (221D). Other modules and components of the NFT engine 100 include:
1. Smart contract deployment and management module (211A), that supports any underlying blockchain
2. TokenID, nonce, airdrop claim management modules (211B) to ensure individual transactions can be processed out of sequence as well in case certain transactions are held up in the execution queue.
3. Deployment wallets and scripts, wallet management including private key management and gas management (211C), with a variety of ways for managing private keys including encryption, utilizing key vaults, multi party computation techniques (MPC) or multi-signature wallet management.
4. Payments modules for both fiat as well as cryptocurrencies (211D) via payment gateways, integrating recording the transaction results and status directly into the blockchain.
5. CustomerID and Nonce management for individual customers (211E), similar to the user side described above, to ensure that transactions by different customers do not queue up and can be processed independently.
6. Integrated web2 and web3 analytics (211F) to map transactional information of users to their wallets. In addition, AI techniques and algorithms can be utilized to infer behavioral information about users independent of their demographic information.
7. Integrated web2 and web3 identity management (211G) that allows for access controls to be implemented based on the digital wallets, ownership of media or avatars, or any other digital goods or identity modules including SSO and SAML.

It may be noted that each of these NFTs is further associated with metadata and wallet address of the users prior to the NFT mint or transfer transaction. It is further noted that the metadata may be provided via an interaction with automated data reporting service processes such as AI agents.

The NFT engine 100 mints and allocates cryptographic experiential tokens entitling the user to access an information stored in the blockchain. In another aspect, token-gated access is granted to a resource providing access to token-gated content in response to a user satisfying specified token criteria.

Web3 represents a shift towards a more decentralized, transparent, and user-centric internet, where individuals have greater control over their online interactions and data. Web3 refers to a next generation of the internet, where decentralized networks, blockchain technology, and cryptocurrencies are integrated to create a more open, secure, and user-centric internet. Unlike Web 2.0, which is characterized by centralized platforms and services controlled by large corporations, Web3 aims to decentralize the internet, giving users more control over their data and online interactions.

In Web3, users interact with decentralized applications (dApps) that run on blockchain networks, such as Ethereum, and communicate through peer-to-peer protocols. This enables trustless transactions, where intermediaries are eliminated, and transparency is ensured through the immutability of blockchain technology.

One of the key features of Web3 is the use of smart contracts, which are self-executing contracts with the terms of the agreement directly written into code. Smart contracts enable automated and tamper-proof agreements, facilitating various applications such as decentralized finance (DeFi), non-fungible tokens (NFTs), decentralized exchanges (DEXs), etc. Smart contracts may also be bound to NFTs to create smart wallets.

As depicted in FIG. 2 an application or dApp may consist of several components including smart contracts deployed or otherwise imported into the application, NFT infrastructure modules such as 211A, 211B, 211C, 211D, 211E, 211F, 211G, asset storage and management (221A, 221C, 221D), or payments (211D).

The system 200 may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application or electronic services, online services, or software platforms. Devices serving as digital wallets may include location-based services capabilities, e.g., GPS, UWB, BLE and other capabilities. Digital wallets may provide a store of value or a credit or access to credit and may be in the form of a digital currency or involve a conversion to digital currency, tradeable digital asset, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other considerations or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions.

The NFT engine application 200A allows users to log in with their email, any social network, or single sign-on service such as Okta. Users can associate their login details with a wallet address on a blockchain (a public key typically) and store a corresponding private key. Users can claim a digital asset by presenting the public key to the application configured with a smart contract, make payments by fiat or crypto, redeem a code, whitelist wallet addresses to mint an asset, and blacklist wallet addresses to block them from interacting with the application.

The application is governed by smart contracts, for example an EVM compatible smart contract. Smart contract deployment and management module 211A allows for unique digital assets (ERC 721), copies of unique digital assets (ERC 1155), mix and match of various other digital assets (ERC998), ERC 6551 (token bound accounts), ERC 4337 (account abstraction and gasless minting) and semi-fungible tokens (ERC3525). It also allows for the rental of digital assets, and assets created via the smart contract can be imported within a metaverse environment.

A smart contract is deployed by creating a private key/wallet address pair separate from any other wallet, known as deployment wallets represented in module 211C. These wallets may hold digital assets (or NFTs) or cryptocurrencies. The deployment wallet may pay for transactions related to the digital assets created via the smart contract, and transactions may be paid by an eventual buyer of the digital assets. The smart contract can be automatically configured and deployed via API calls, on-demand or in real-time, and on a choice of blockchains or test network environments. Payments (fiat and crypto) are handled by module 211D.

Digital assets are stored, and they may or may not be transferable to any other wallet address on the blockchain. Payments are processed by module 211D by storing the confirmation ID and token ID as proof of payment on the blockchain when the token is minted.

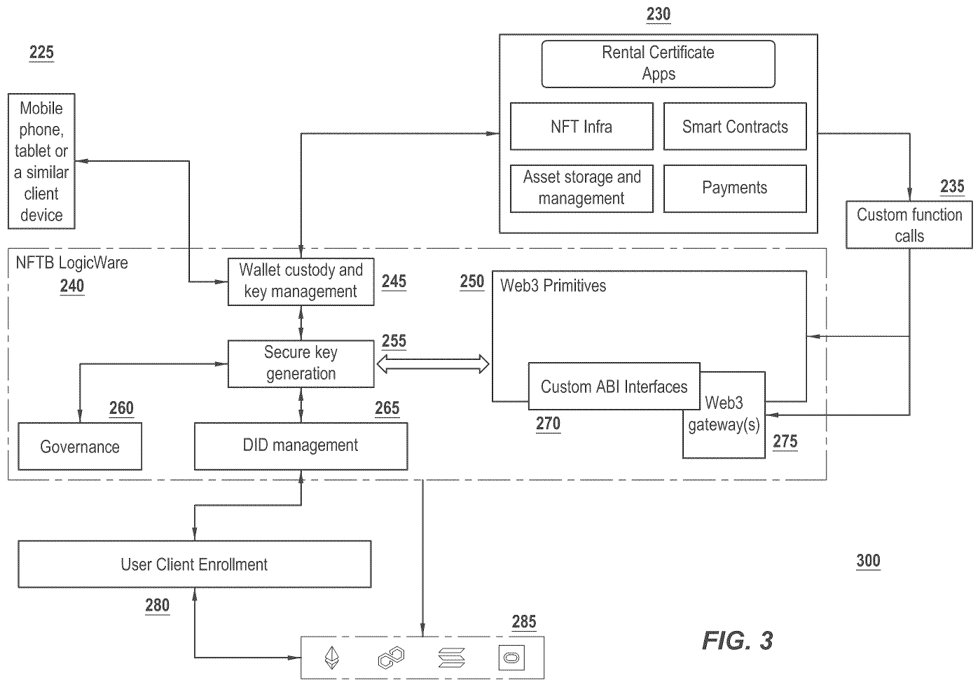

FIG. 3 illustrates an exemplary high level architectural view 300 of a NFT-based carbon credits system wherein the capabilities and features of NFT engine 100 of FIG. 2 are incorporated into LogicWare 240 as Web3 Primitives 250. Various other components and modules can be added to this architecture to accommodate customized NFT requirements.

The end user logs into the platform using a mobile phone, tablet or other networked device (225). The application running on the device interacts with rental certificate application 230 via the NFT LogicWare 240. Similar in capability to middleware platform 205, LogicWare 240 determines the wallet custody and key management protocol 245 that applies to the particular carbon credit or carbon credit marketplace 230 and its user and logs the user in into the application. If the user interacts with the application or dApp the first time, the custody and key management protocol 245 generates a new key pair using the secure key generation module 255 for the user and associates it with the user's digital identity. Optionally secure key generation 255 may also associate the keys with a decentralized identity and issue verified credentials to the user. Additionally, LogicWare 240 also creates or associates the governance policies 260 that the user identity may be subject to. If the user is a returning user, the LogicWare retrieves the keys and based on the governance and access control rights, allows the user to access the application or the dApp. As depicted in FIG. 2 the application or dApp may consist of several components including smart contracts deployed via the module 211A or otherwise imported into the application, NFT infrastructure modules such as 211A, 211B, 211C, 211D, 211E, 211F, 211G, asset storage and management (221A, 221C, 221D), or payments (211D).

The applications 230 interface with LogicWare 240 (NFT middleware) via custom function calls APIs and SDK's (235). The LogicWare 240 for NFTs includes various Web3 primitives, 250, that are interoperable building blocks that are highly reliable in executing transactions over a blockchain providing similar features and capabilities as the NFT engine 100 described in system 200 including communicating with backend and frontend systems, work with storage components (e.g., 221C, 221D), utilize analytics from modules, similar to web2 and web3 analytics (211F), identify users using an identity management module, secure the applications using authentication, identity management, or implement access controls with 211G, 211B, etc. or provide for a governance layer in combination with the governance module 260. Web3 primitives 250 also communicate with custom ABI interfaces, 270, and web3 gateways 275 for deploying smart contracts to their respective blockchains, interacting with smart contracts, and executing the functions and instructions in the smart contracts.

LogicWare 240 optionally comprises a governance (260) and a Decentralized Identity (DID) management module (265). DIDs are an important part of securing identity and making it interoperable across both web2 and web3 platforms.

Applications in web3 are also referred to as dApps. Governance in decentralized applications (dApps) in and communities refers to the processes and mechanisms through which decisions are made and actions are taken within the decentralized ecosystem. In traditional centralized systems, governance is typically controlled by a central authority, whereas in decentralized systems, governance is distributed among network participants. In one embodiment, the decision making and governance is in part based on the decentralized identity of the users themselves, who interact with the dApp and the associated smart contracts with their wallets and their corresponding private keys. The Governance module 260 within the LogicWare allows for implementing various governance mechanisms and resource allocations. In conjunction with the DID management module 265, the governance module 260 also employs mechanisms to prevent Sybil attacks or other malicious attacks on the system, such as, where an individual may create multiple identities to gain disproportionate influence for voting purposes. Sybil resistance mechanisms can include reputation systems, stake-weighted voting, or identity verification to ensure that governance decisions are made by genuine participants.

The DID management module 265 handles web2 and web3 identity management. The module utilizes methods for decentralized technologies, such as distributed ledgers (e.g., blockchain) or peer-to-peer networks, to enable the creation, management, and verification of DIDs and associated digital identities. As such, the DID created for any user can be used as an identity across any blockchain and helps identify the user on the application, without compromising the user's actual identity or demographic information. The users retain full control over their DID and can choose to lock and selectively share their information using their DIDs. In particular, this is an efficient way of combining various private blockchain systems favored by enterprises, with the public blockchain systems. With a DID, a user can retain the same wallet address to make transactions over any supported blockchain.

Various blockchains may have different ways to monitor and govern the identity of the users. In order to map the identity from one system to another, it may be necessary to homogenize the identity across the multiple platforms by implementing a client enrollment module 280 to create a system where the identities from one system may map directly to an identity on another system, without the need for any user intervention. For example, when making a private blockchain system to be compatible with a public blockchain such as Ethereum, Polygon, Base or Solana, it may be essential to create a user (client) enrolment into the Hyperledger based system and map it to the private keys for the eventual user of the system.

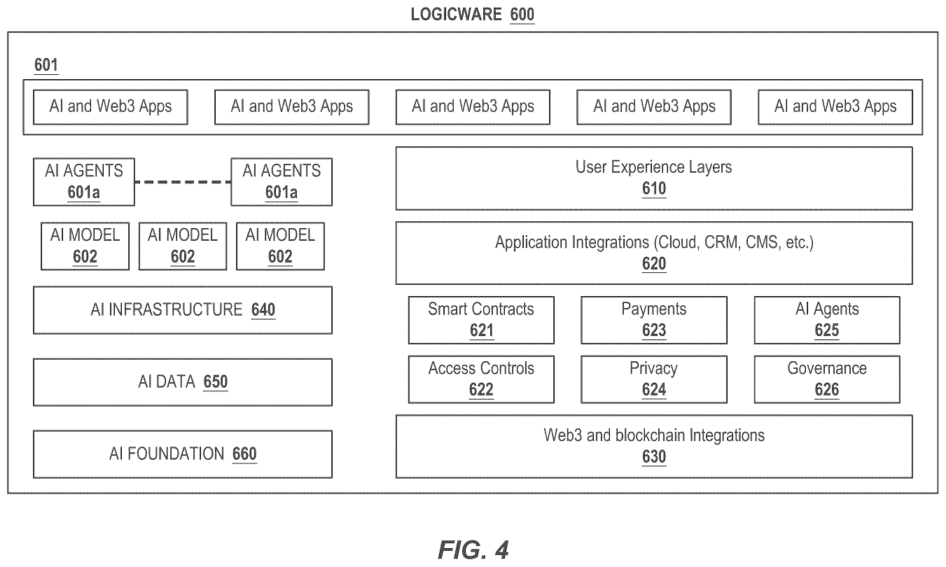

FIG. 4 illustrates the use of verified credentials (VCs) for authentication into the ecosystem of applications 400 for access control or user onboarding features.

When a user logs in to the platform using a mobile phone, tablet, desktop, or a similar device, 231, the onboarding application, 236, or dApp issues a verified credential (VC), to the user. It may be noted that the VC may be issued by a third party application separately and imported into the client application. These VCs allow the user to access other connected applications or dApps that the user may wish to, such as loyalty programs, using their decentralized identity. As such, verified credentials (VCs) act as an authentication mechanism for users to use the appropriate wallets as a proxy for their identity on the system. A user may have multiple wallets associated with their identity. When a user logs in to the application or dApp, the LogicWare 256 for this embodiment identifies the appropriate identity to use and retrieves the appropriate keys from the key management system, 251. This in turn allows the application or dApp, 246, to transact with the blockchain using the appropriate identity and the private keys associated with them. A user's public key may be stored on the blockchain which allows anyone to verify the authenticity of messages, transactions, or other data associated with that identity. LogicWare 256 operates in a similar fashion to the LogicWare 240.

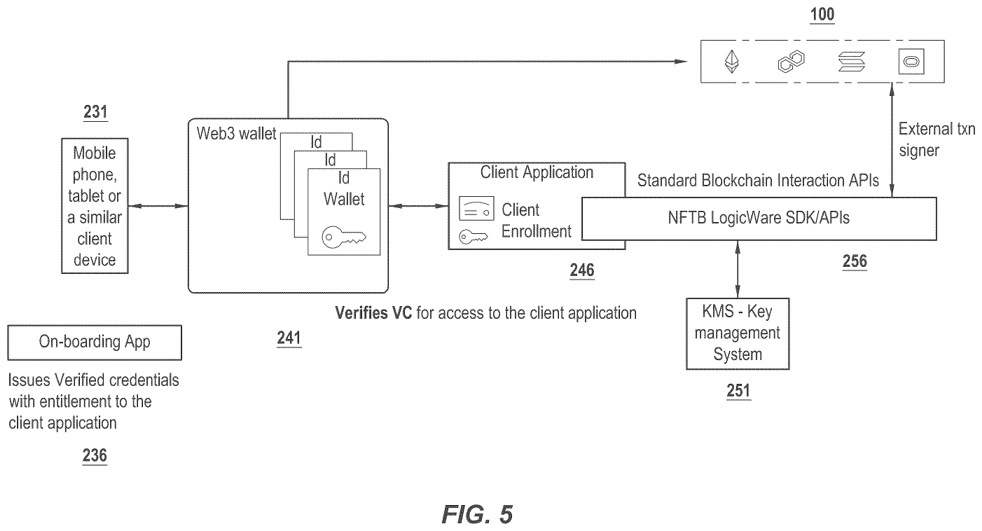

FIG. 5 is a detailed block diagram 500 illustrating an NFT carbon credit module 120 of the system of FIG. 1, according to an embodiment.

The NFT carbon credit module 120 is detailed in FIG. 5, and includes a carbon usage module 310 and carbon profile module 320 where various data elements from across various industries can be used for creating NFT collections or blockchain based records that may be relevant to a business in that particular industry. For example, a) Energy consumption data: Energy consumption data, such as electricity and fuel use, can be used to calculate greenhouse gas emissions or reductions achieved thereof using more efficient equipment from operations. This data can be collected through energy bills and meter readings; b) Transportation data: Transportation is a significant source of greenhouse gas emissions or reductions achieved thereof using more efficient equipment. Data on the number of vehicles, miles driven, and fuel use can be used to calculate emissions from transportation telemetry systems; c) Waste data: Waste disposal is another significant source of greenhouse gas emissions or reductions achieved thereof using more efficient equipment. Data on the amount and type of waste generated, as well as the disposal method, can be used to calculate emissions from waste; d) Land use data: Land use changes, such as deforestation, can result in significant greenhouse gas emissions or reductions achieved thereof using more efficient equipment. Data on land use changes can be used to calculate emissions from deforestation and forest degradation; e) Emission factors: Emission factors are coefficients that relate greenhouse gas emissions or reductions achieved thereof using more efficient equipment to a specific activity or input, such as fuel use or electricity consumption. These factors can be used to estimate emissions when data is not available; f) Satellite data: Satellite data can be used to monitor land use changes, such as deforestation and forest degradation, as well as emissions from large industrial sources; and g) Carbon accounting software: Carbon accounting software can be used to track emissions from operations, transportation, and waste disposal. This software can also generate carbon credits by calculating emissions reductions from specific projects or initiatives.

The NFT carbon credit module 120 can register and track carbon credits for individual consumers on a block chain. A carbon usage module 310 monitors and records emissions from one or more sources associated with carbon consumers. A carbon profile module 320 maintains public metadata and private metadata. An NFT processing module 330 uses a back end block chain system such as NFT engine 110 for NFT and blockchain transactions, preferably transparent to users. A network module 340 uses communication channels such as Ethernet and cellular data to exchange information across the data communication network 199.

Carbon credits can be registered, verified and traded through the use of non-fungible tokens, or NFTs. An NFT is a unique digital asset that is stored on a blockchain, a decentralized and secure digital ledger. It is envisioned that carbon credits can be represented as NFTs, and the data as well as metadata associated with the NFTs can provide the requisite transparency for third parties to independently verify the authenticity of these carbon credit certificates.

One potential application of carbon credits and NFTs is in the transportation sector. By using telemetry data from vehicles, it is possible to track and verify the amount of greenhouse gas emissions that are being generated by different modes of transportation. Transportation accessories such as aerodynamic enhancements, low resistance tires, turbo boosters such as hydrogen fuel etc. can significantly contribute to enhancing the fuel efficiency of vehicles. As such, an objective comparison can be made between telemetry data of vehicles with and without efficiency improvements. The gain in efficiency can be converted to meaningful carbon savings that can be monetized via carbon credits. All of this data is significant and meaningful for large fleet operators, transportation companies, and supply chain and logistics companies that can be incentivized to create their own carbon credits based on realized gains from efficient practices.

In addition to the telemetry data from vehicles, carbon credits and NFTs could also be used in conjunction with other available public and private metadata. Public metadata could include information about the type and age of the vehicle, as well as the routes that it typically travels. Private metadata could include information about the driver, such as their driving habits and history, the materials used in the accessories, or compounds used for low rolling resistance of the tires.

By combining this data with carbon credits and NFTs, it would be possible to create a more efficient and transparent market for the trading of carbon credits. This could help to incentivize the reduction of greenhouse gas emissions in the transportation sector, ultimately benefiting the environment. Additionally, the use of NFTs would help to prevent fraud and double-spending in the carbon credit market.

Additionally, AI agents can be used to facilitate automated data reporting service processes that may interact with any of the modules.

AI agents are software programs that employ artificial intelligence techniques to operate autonomously or semi-autonomously in a variety of environments, making decisions based on input data, predefined rules, machine learning models, or a combination of these methodologies. Typically, AI agents are capable of performing tasks independently without human intervention, adjusting their actions based on the analysis of incoming data. In this way they are an extension of an analytics engine and make it easy to take actions based on the underlying analysis for the data that they operate upon, such as performance or other informational data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks. The output of AI agents can be information that can be represented as metadata and associated with an NFT. In one embodiment AI agents can be used to process data and create metadata that can be immutably recorded and attached to an NFT.

These AI agents can be implemented using a variety of technical frameworks and methodologies, including but not limited to:

Machine Learning and Deep Learning: Utilizing algorithms and neural networks to analyze data, recognize patterns, and make decisions.

Natural Language Processing (NLP): Enabling the understanding and generation of human language, facilitating interactions between humans and machines.

Robotics: Applying AI in mechanical or virtual robots, connected devices, IoT (Internet of Things) devices, etc. allowing for physical interaction with environments.

Expert Systems: Incorporating rule-based systems that mimic the decision-making abilities of a human expert.

Data Analysis Systems: Designed to interpret vast datasets efficiently and accurately to derive meaningful insights.

AI agents can be used to facilitate automated data reporting service processes that may interact with the carbon profile module 320 automatically. Such automated data reporting service processes may include:
1. Database services designed to manage, query, and report data from relational, non-relational, or vectorized databases efficiently.
2. Business intelligence tools that collect and process large amounts of unstructured data from internal and external systems, prepare it for analysis, develop queries against that data, and create reports, dashboards, and data visualizations.
3. Data Warehousing Solutions that aggregate data from multiple sources, making it easier to provide comprehensive reporting and analysis. They often include tools for automated reporting and data analysis.
4. AI powered analytics platforms that use artificial intelligence to analyze data and generate reports. They can identify patterns, trends, and anomalies without human intervention.
5. AI agents that meet specific business needs, capable of extracting data from various sources, analyzing it using machine learning models, and generating tailored reports. These agents can be trained to provide insights specific to the business's operational, tactical, or strategic queries.

These automated data processing reporting services may also include spreadsheet tools with automation features, API based tools, cloud based reporting services, ETL (extract, transform, load) tools or any combination of the above.

### A. Artificial Intelligence for Gathering and Analyzing Data

FIG. 4 is a block diagram further illustrating elements of the LogicWare with blockchain, AI and Web3 interfaces.

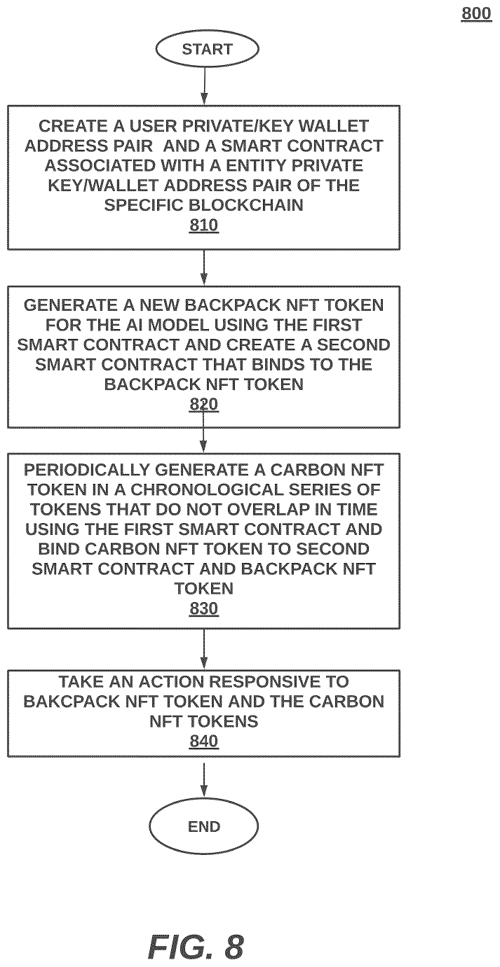

The Logicware system 800 depicted in FIG. 8 abstracts away many of the complexities involved in building and operationalizing AI systems, enabling developers and applications to focus on leveraging AI capabilities rather than dealing with low-level infrastructure concerns. AI Foundation 660 refers to the underlying platform enabling the integration and deployment of artificial intelligence capabilities within LogicWare 800. The AI Foundation 660 serves as a common layer that provides essential services and components required for developing, deploying, and managing AI models and applications. AI Foundation may be part of the LogicWare 800 deployed as SDKs or made available to Logicware via APIs. AI Foundation may include or support the following key elements:

Data ingestion and preprocessing: Components for collecting, cleaning, and preprocessing data from various sources to prepare it for use in AI models.

Model development and training: Tools and environments for building, training, and evaluating AI models 602, such as machine learning, deep learning, or natural language processing models.

Model management: Services for versioning, storing, and managing trained AI models 602, as well as monitoring their performance and updating them as needed.

Inference and deployment: Mechanisms for deploying trained AI models into production environments, allowing applications and systems to consume and leverage the AI capabilities.

Scalability and performance: Infrastructure 640 and services that enable the efficient scaling and high-performance execution of AI workloads, often involving specialized hardware like GPUs or TPUs and cloud-based services.

Security and governance: Mechanisms for ensuring the secure and compliant use of AI models, including access control, auditing, and adherence to regulatory requirements.

Integration and APIs: Interfaces with Application Integrations 630 and APIs that allow other applications and systems to seamlessly integrate and consume the AI capabilities provided by the foundation such as process systems 621-626.

AI Foundation 660 aims to provide a standardized and consistent platform for AI development and deployment with Logicware 110, across the organization, promoting reusability, scalability, and governance of AI solutions. Some of the features of the AI Foundation 660, may also integrate with cloud, CRM, CMS and other systems via Application Integrations 620.

AI Data 650 refers to the information used to train and develop artificial intelligence systems. This data can be in various forms, such as text, images, audio, or numerical data, depending on the application of the AI system. Ensuring the quality, relevance, and diversity of AI data is crucial for building accurate and unbiased AI models. AI data can be both structured and unstructured:
1) Structured data refers to information that is organized and formatted in a predefined way, such as databases, spreadsheets, or labeled datasets. This type of data is typically used for tasks like classification, regression, or structured prediction problems.
2) Unstructured data, on the other hand, refers to information that does not have a predefined format or structure, such as text documents, images, audio files, or social media posts. This type of data requires more preprocessing and feature extraction techniques before it can be used for training AI models.
3) Many AI applications, especially in areas like natural language processing (NLP) and computer vision, rely heavily on unstructured data, while structured data is more commonly used in fields like finance, healthcare, and manufacturing.

Logicware works with both structured and unstructured data which can also be integrated via application integrations 620.

AI infrastructure 640 refers to the combination of hardware and software resources required to develop, train, and deploy artificial intelligence systems effectively. It includes powerful computing resources, such as GPUS, TPUs, or specialized AI accelerators, to handle the computationally intensive tasks involved in training large AI models. AI infrastructure also encompasses the software platforms, frameworks, and tools used for data preprocessing, model building, training, and inferencing, which may also be a part of the AI Foundation. Additionally, AI Infrastructure 640 may involve storage and data management solutions to handle the vast amounts of data required for AI model training. The system in FIG. 8 enables robust AI infrastructure is crucial for organizations to scale their AI initiatives and achieve efficient model development and deployment cycles.

AI models are mathematical representations or algorithms that are trained on data to learn patterns, make predictions, or take actions. They are the core components of artificial intelligence systems that enable them to perform specific tasks, such as image recognition, natural language processing, or decision-making. AI models can be deep learning models, like convolutional neural networks or transformers, or more traditional machine learning models like decision trees or support vector machines. The performance and accuracy of an AI model depend on the quality and quantity of the training data, the model architecture, and the techniques used for training and optimization.

AI agents are software programs that employ artificial intelligence techniques to operate autonomously or semi-autonomously in a variety of environments, making decisions based on input data, predefined rules, machine learning models, or a combination of these methodologies. Typically, AI agents are capable of performing tasks independently without human intervention, adjusting their actions based on the analysis of incoming data. In this way they are an extension of an analytics engine and make it easy to take actions based on the underlying analysis for the data that they operate upon, such as carbon credit information data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks.

These AI agents can be implemented using a variety of technical frameworks and methodologies, including but not limited to:

Machine Learning and Deep Learning: Utilizing algorithms and neural networks to analyze data, recognize patterns, and make decisions.

Natural Language Processing (NLP): Enabling the understanding and generation of human language, facilitating interactions between humans and machines.

Robotics: Applying AI in mechanical or virtual robots, connected devices, IoT (Internet of Things) devices, etc. allowing for physical interaction with environments.

Expert Systems: Incorporating rule-based systems that mimic the decision-making abilities of a human expert.

Data Analysis Systems: Designed to interpret vast datasets efficiently and accurately to derive meaningful insights.

In FIG. 8, system 800 can support a range of AI and Web3 applications via interfaces 601. AI applications can be utilized in a wide range of fields, including computer vision for object detection and recognition, natural language processing for text analysis and generation, predictive analytics for forecasting and decision support systems, as well as robotics and automation for task planning and control. The proposed invention leverages novel AI models and algorithms to achieve improved performance, efficiency, or functionality compared to existing approaches. These applications can find use in a variety of different industries and for numerous use cases such as healthcare diagnostics, financial fraud detection, recommendation systems, language processing, customer service, etc. The AI application can be implemented on various hardware platforms, such as cloud computing infrastructure, edge devices, or specialized AI accelerators, enabling scalable and cost-effective deployment.

Various cloud vendors provide platforms and services that support the development and deployment of AI agents. These cloud vendors are continuously adding support features, improved capability and services in support of their cloud offerings. Some of the major providers include Amazon Web Services (AWS) (Amazon Lex: A service for building conversational interfaces into any application using voice and text; Amazon Polly: A service that turns text into lifelike speech, allowing users to create applications that talk; Amazon Rekognition: A service for adding image and video analysis to applications; Amazon Comprehend: A natural language processing (NLP) service for understanding the content of text documents; Amazon SageMaker: A fully managed service that provides developers and data scientists with the ability to build, train, and deploy machine learning (ML) models); Microsoft Azure (Azure Bot Service: A service that enables you to build intelligent, enterprise-grade bots that help enrich the customer experience while reducing costs; Azure Cognitive Services: A set of APIs, SDKs, and services available to help developers build intelligent applications without having direct AI or data science skills; Azure Machine Learning: A cloud-based environment that a user can use to train, deploy, automate, and manage machine learning models0; Google Cloud Platform (GCP) (Google Dialogflow: A natural language understanding platform that makes it easy to design and integrate a conversational user interface into mobile app, web application, device, bot, interactive voice response system, and more; Google Cloud Speech-to-Text and Text-to-Speech: APIs for converting audio to text and vice versa; Google Cloud Vision API: Enables developers to understand the content of an image by encapsulating powerful machine learning models in an easy-to-use REST API; and Cloud Natural Language API: Provides natural language understanding technologies to developers).

These cloud vendors offer a wide range of AI and machine learning tools and services, enabling developers to create sophisticated AI agents, chatbots and virtual assistants.

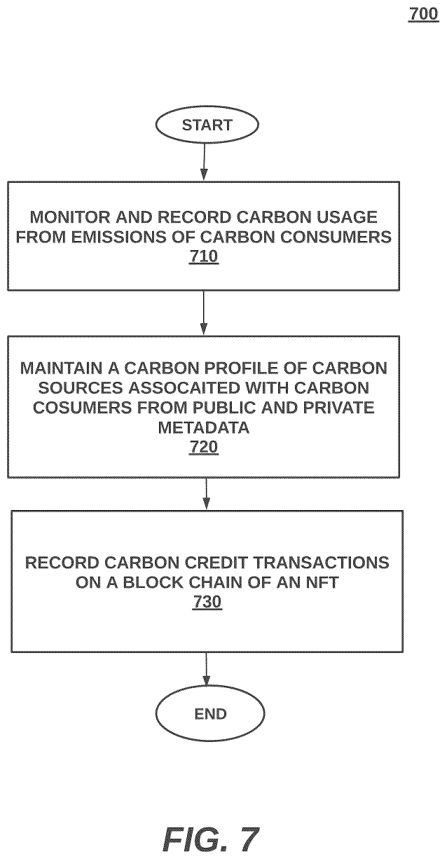

### III. Methods for NFT Carbon Credit Tracking (FIG. 7-8)

FIG. 7 is a high-level flow diagram illustrating a method 600 for registering and tracking carbon credits with NFTs, according to one embodiment. At step 710, Carbon usage is monitored and recorded from emissions of one or more sources associated with carbon consumers. At step 720, public and private metadata about sources are maintained. At step 730, a block chain of an NFT records carbon credit transactions.

FIG. 8 is an alternative more detailed flow diagram illustrating a method 600 for registering and tracking carbon credits with NFTs, according to one embodiment.

At step 810, an entity private key/wallet address pair associated with a specific enterprise is created.

At step 820, a first smart contract using the entity private key/wallet address pair is created.

At step 830, using the first smart contract, a new backpack NFT token representing a project is generated.

At step 840, a second smart contract that binds to the backpack NFT token is created.

At step 850, project data that corresponds to the project's carbon activity is ingested and stored in a database.

At step 860, using the first smart contract, a carbon NFT token in a series of tokens is periodically generated, from the ingested project data, wherein the series of tokens do not overlap in time.

At step 870, the carbon NFT token to the second smart contract with the backpack NFT token.

At step 880, an action is taken, responsive to the backpack NFT token and the carbon NFT tokens of the series of tokens.

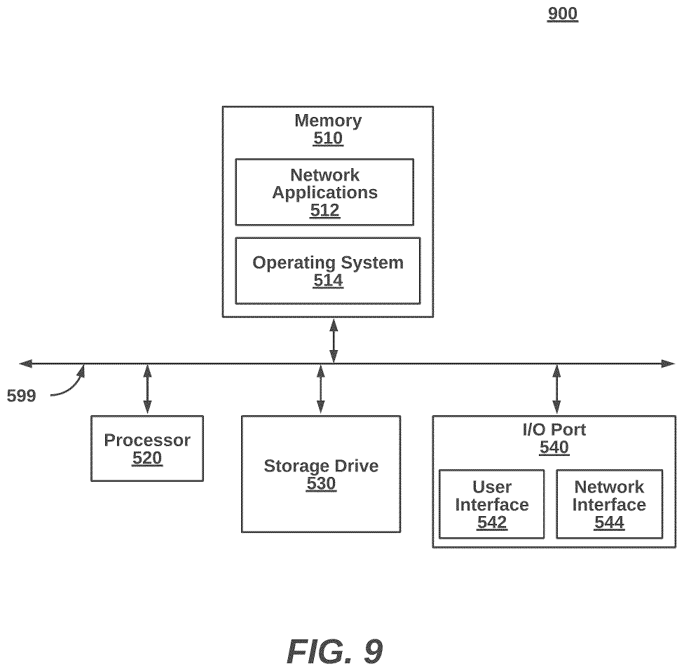

### III. Computing Device for NFT Carbon Credit Tracking (FIG. 9)

FIG. 9 is a block diagram illustrating a computing device 900 for use in the system 100 of FIG. 1, according to one embodiment. The computing device 700 is a non-limiting example device for implementing each of the components of the system 100, including NFT engine 110, NFT carbon credit module 120 and a carbon consumer device 130. Additionally, the computing device 500 is merely an example implementation itself, since the system 100 can also be fully or partially implemented with laptop computers, tablet computers, smart cell phones, Internet access applications, and the like.

The computing device 500, of the present embodiment, includes a memory 510, a processor 520, a hard drive 530, and an I/O port 540. Each of the components is coupled for electronic communication via a bus 599. Communication can be digital and/or analog, and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access application, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X, etc., Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing element. The processor 520 can be disposed on silicon or any other suitable material. The processor 520 can receive and execute instructions and data stored in the memory 510 or the hard drive 530.

The storage device 530 can be any non-volatile type of storage such as a magnetic disc, EPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

1. A computer-implemented method in a system, on a data communication network, for providing immutable information about carbon credits and associated data tracked with a non-fungible cryptographic token (NFT) based carbon certificate, the method comprising:
creating an entity private key/wallet address pair associated with a specific enterprise;
creating a first smart contract using the entity private key/wallet address pair;
using the first smart contract, generating a new backpack NFT token representing a project;
creating a second smart contract that binds to the backpack NFT token;
ingesting project data that corresponds to the project's carbon activity and storing it in a database;
using the first smart contract, periodically generating a carbon NFT token in a series of tokens, from the ingested project data, wherein the series of tokens do not overlap in time;
binding the carbon NFT token to the second smart contract and the backpack NFT token; and
taking an action, responsive to the backpack NFT token and the carbon NFT tokens of the series of tokens.

2. A non-transitory computer-readable medium in a rental verification system, on a data communication network, storing code that when executed, performs a method for providing immutable information about carbon credits and associated data tracked with a non-fungible cryptographic token (NFT) based carbon certificate, the method comprising:
creating an entity private key/wallet address pair associated with a specific enterprise;
creating a first smart contract using the entity private key/wallet address pair;
using the first smart contract, generating a new backpack NFT token representing a project;
creating a second smart contract that binds to the backpack NFT token;
ingesting project data that corresponds to the project's carbon activity and storing it in a database;
using the first smart contract, periodically generating a carbon NFT token in a series of tokens, from the ingested project data, wherein the series of tokens do not overlap in time;
binding the carbon NFT token to the second smart contract and the backpack NFT token; and
taking an action, responsive to the backpack NFT token and the carbon NFT tokens of the series of tokens.

3. A carbon credit tracking system, on a data communication network, for providing immutable information about carbon credits and associated data tracked with a non-fungible cryptographic token (NFT) based carbon certificate, the carbon credit tracking system comprising:
a processor;
a network interface communicatively coupled to the processor and to a data communication network; and
a memory, communicatively coupled to the processor and storing:
a first module to create an entity private key/wallet address pair associated with a specific enterprise;
a second module to create a first smart contract using the entity private key/wallet address pair;
a third module to, using the first smart contract, generate a new backpack NFT token representing a project;
a fourth module to create a second smart contract that binds to the backpack NFT token;
a fifth module to ingest project data that corresponds to the project's carbon activity and storing it in a database;
a sixth module to, using the first smart contract, periodically generate a carbon NFT token in a series of tokens, from the ingested project data, wherein the series of tokens do not overlap in time;
a seventh module to bind the carbon NFT token to the second smart contract and the backpack NFT token;
an eight module to take an action, responsive to the backpack NFT token and the carbon NFT tokens of the series of tokens.
